(19) United States
(12) Patent Application Publication
(10) Pub. No.: US 2012/0111658 A1
(43) Pub. Date: May 10, 2012

(54) VEHICULAR STEERING CONTROL APPARATUS

(75) Inventors: Masashi Hori, Anjo-city (JP); Yasuhiko Mukai, Anjo-city (JP); Kouichi Nakamura, Toyota-city (JP)

(73) Assignees: Nippon Soken, Inc., Nishio-city (JP); DENSO CORPORATION, Kariya-city (JP)

(21) Appl. No.: 13/287,389

(22) Filed: Nov. 2, 2011

(30) Foreign Application Priority Data
Nov. 4, 2010 (JP) 2010-247549

(51) Int. Cl. B62D 6/10; B62D 5/04

(52) U.S. Cl. 180/446

(57) ABSTRACT

A vehicular steering control apparatus has a steering direction control device and a reaction force application device. The steering direction control device controls a steering angle of steered wheels by controlling a steering direction control motor based on a steering wheel angle. The reaction force application unit is provided more closer to a steering wheel than the steering direction control device is and has a differential reduction unit and a reaction force application motor. The differential reduction unit transfers rotation of an input shaft to an output shaft. The reaction force application motor drives the differential reduction unit. The steering wheel and the steered wheels are normally linked mechanically, so that no fail-safe device is needed.

### CROSS REFERENCE TO RELATED APPLICATION

This application is based on and incorporates herein by reference Japanese patent application No. 2010-247549 filed on Nov. 4, 2010.

### FIELD OF THE INVENTION

The present invention relates to a vehicular steering control apparatus, which controls steering angle of steered wheels of a vehicle.

### BACKGROUND OF THE INVENTION

A conventional steer-by-wire type steering system for a vehicle electrically drives steered wheels without using torque applied to a steering wheel. According to JP 4248390, JP 2007-1564A and JP 2010-69895A, the steering wheel and the steered wheels are normally not linked mechanically.

According to the steering systems (referred to as full by-wire type steering system below), in which the steering wheel and the steered wheels are normally not linked mechanically, a fail-safe device need be provided separately from the full by-wire type system for a case that failure arises in the system. The system is therefore complicated because of the fail-safe device, which does not operate normally.

According to a conventional electric power steering apparatus (referred to as EPS apparatus below), a steering wheel and steered wheels are linked mechanically. In controlling steering reaction force applied to the steering wheel in the conventional EPS apparatus, it is possible to control the reaction force based on turning force of the steered wheels. However, the direction of the steering force to the steered wheels and the direction of the reaction force to the steering wheel do not necessarily coincide. It is therefore not possible to appropriately control the reaction force.

### SUMMARY OF THE INVENTION

It is an object of the present invention to provide a vehicular steering control apparatus, which is capable of appropriately controlling steering reaction force applied to a steering member in simple configuration.

According to the present invention, a vehicular steering control apparatus has an input shaft, an output shaft, a steering gear box device, an operation amount detection part, a steering direction control device and a steering reaction force application device. The input shaft is coupled to a steering member operable by a driver. The output shaft is provided rotatably relative to the input shaft. The steering gear box device converts rotary motion of the output shaft to linear motion and varies a steering angle of steered wheels. The operation amount detection part detects an operation amount of the input shaft, which varies with steering operation of the steering member. The steering direction control device includes a first motor and is configured to control the steering angle of the steered wheels by driving the first motor based on the operation amount of the input shaft detected by the operation amount detection part. The steering reaction force application device is provided closer to the steering member than the steering direction control device is and includes a differential reduction unit and a second motor, the differential reduction unit couples the input shaft and the output shaft to transfer rotation of the input shaft to the output shaft. The second motor drives the differential reduction unit. The steering reaction force application device is configured to apply steering reaction force to the steering member by operation of the second motor.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram of a vehicular steering control system according to a first embodiment of the present invention;

FIG. 2 is a schematic diagram of the steering control system according to the first embodiment of the present invention;

FIG. 3 is a sectional view of a steering control module in the first embodiment of the present invention;

FIG. 4 is a sectional view taken along a line IV-IV in FIG. 3;

FIG. 5 is a flowchart showing steering angle control processing in the first embodiment of the present invention;

FIG. 6 is a flowchart showing steering angle target value calculation processing in the first embodiment of the present invention;

FIG. 7 is a flowchart showing steering angle feedback control calculation processing in the first embodiment of the present invention;

FIG. 8 is a flowchart showing PWM command value calculation processing in the first embodiment of the present invention;

FIG. 9 is a graph showing in a map form a relation between a vehicle speed and a speed increase ratio in the first embodiment of the present invention;

FIG. 10 is a flowchart showing reaction force application control processing in the first embodiment of the present invention;

FIG. 11 is a flowchart showing reaction force target value calculation processing in the first embodiment of the present invention;

FIG. 12 is a flowchart showing reaction force feedback control calculation processing in the first embodiment of the present invention;

FIG. 13 is a flowchart showing PWM command value calculation processing in the first embodiment of the present invention;

FIG. 14 is a graph showing in a map form a relation between a steering wheel angle and a load reaction force target value in the first embodiment of the present invention;

FIG. 15 is a graph showing in a map form a relation between a steering wheel angular velocity and a friction reaction force target value in the first embodiment of the present invention;

FIG. 16 is a flowchart showing reaction force application control processing in a second embodiment of the present invention;

FIG. 17 is a flowchart showing reaction force feedback control calculation processing in the second embodiment of the present invention; and

FIG. 18 is a schematic view of a steering control system according to the other embodiment of the present invention.

### DETAILED DESCRIPTION OF THE EMBODIMENT

A vehicular steering control apparatus according to the present invention will be described with reference to various embodiments. In the following embodiments, same or similar parts are denoted with same reference numerals for brevity.

### First Embodiment

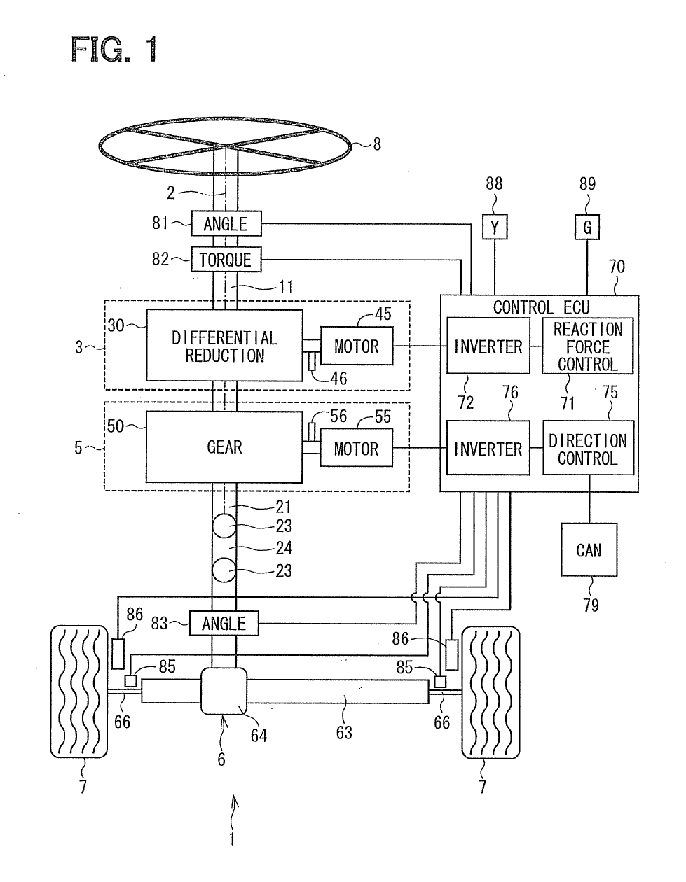

A vehicular steering control apparatus 1 according to a first embodiment of the present invention is shown in FIGS. 1 to 15. The steering control apparatus 1 is formed of a column shaft 2, a steering reaction force application device 3, a steering direction control device 5, a steering gear box device 6, left and right steered wheels (left and right tire wheels) 7, a steering wheel 8 as a steering member, a control ECU 70 and the like.

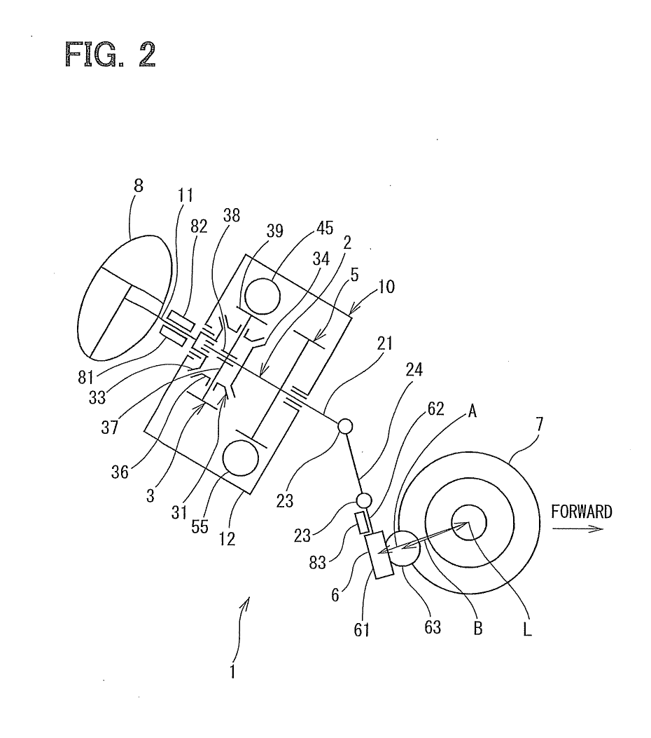

The reaction force application device 3 includes a differential reduction unit 30, a reaction force application motor 45 as a second motor and the like. The direction control device 5 includes a gear unit 50, a direction control motor 55 as a first motor and the like. The reaction force application motor 45 and the steering direction control motor 55 are controlled and driven by the control ECU 70. As shown in FIG. 2 and the like, the reaction force application device 3 and the direction control device 5 are mounted about the column shaft 2, and the reaction force application device 3 is mounted closer to the steering wheel 8 side than the direction control device 5. That is, the reaction force application device 3 is located between the direction control apparatus 5 and the steering wheel 8.

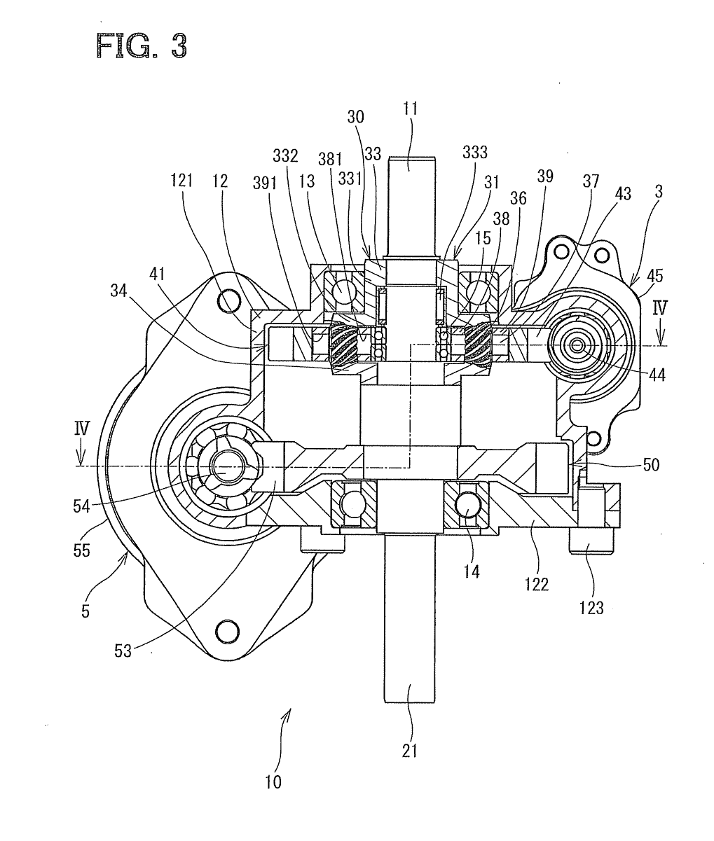

As shown in FIG. 2, the reaction force application device 3 and the direction control device 5 are accommodated within a housing 12. The reaction force application device 3 and the direction control device 5 are integrated into a single body as a steering control module 10, so that the apparatus is compact-sized. The steering control module 10 will be described later with reference to FIG. 3 and the like.

The column shaft 2 is formed of an input shaft 11 and an output shaft 21. The output shaft 21 is linked to an intermediate shaft 24 through a universal joint 23. The input shaft 11 is linked to the steering wheel 8, which is operated by a driver. The input shaft 11 is provided with a steering wheel angle sensor 81 and a torque sensor 82. The steering wheel angle sensor 81 detects a steering wheel angle θh, which is a rotation angle of the input shaft 11. The torque sensor 82 detects an input shaft torque Tsn generated by the input shaft 11. The steering wheel 8 and the input shaft 11 are coupled. The steering wheel angle sensor 81 corresponds to an operation amount detection part and the steering wheel angle θh corresponds to an operation amount of the input shaft 11, which varies with the operation amount of the steering wheel 8. The steering wheel angle θh is assumed to be positive and negative when the steering wheel 8 is operated in the clockwise direction and in the counter-clockwise direction, respectively.

The output shaft 21 is provided coaxially with the input shaft 11 on the column shaft 2 and relatively rotatable to the input shaft 11. The direction of rotation of the output shaft 21 is reversed relative to that of the input shaft 11 by operation of the differential reduction unit 30.

The steering gear box device 6 includes a steering pinion 61, a steering rack bar 63 and the like and is provided more rearward in a vehicle from a line (indicated by L in FIG. 2), which connects rotation centers of the steered wheels 7 at the left side and the right side. The steering pinion 61 and the steering rack bar 63 are housed in a steering gear box 64. The steering pinion 61, which is a disk-shaped gear, is provided at an end of the column shaft 2 to be opposite to the steering wheel 8. The steering pinion 61 rotates in both forward and reverse directions with the output shaft 21 and the pinion shaft 62. A pinion angle sensor 83 is provided on the pinion shaft 62 to detect a pinion angle θp, which is a rotation angle of the pinion shaft 62.

Rack teeth formed on the steering rack bar 63 meshes the steering pinion 61 and converts the rotary motion of the steering pinion 61 to the linear motion of the steering rack bar 63 in the left and right directions of the vehicle. The steering gear box device 6 thus converts the rotary motion of the output shaft 21 into the linear motion.

A distance A between the steering pinion 61 and the line L connecting the rotation centers of the left and right steered wheels 7 is set longer than a distance B between the steering rack bar 63 and the line L. The output shaft 21 rotates in the opposite direction from that of the input shaft 11 due to operation of the differential reduction unit 30 provided between the input shaft 11 and the output shaft 21. If the steering wheel 8 is rotated in the left direction, the steering pinion 61 rotates in the clockwise direction when viewed from the pinion shaft 62 side. The steering rack bar 63 moves in the right direction and the steering angle of the steered wheels 7 is changed thereby to direct the vehicle in the left direction. If the steering wheel 8 is rotated in the right direction, the steering pinion 61 rotates in the counter-clockwise direction when viewed from the pinion shaft 62 side. The steering rack bar 63 moves in the left direction and the steering angle of the steered wheels 7 is changed thereby to direct the vehicle in the right direction.

As described above, the distance A between the steering pinion 61 and the line L is set longer than the distance B between the steering rack bar 63 and the line L. That is, the distances A and B are set to satisfy A>B. As a result, the steered wheels 7 are steered in the direction opposite to the rotation direction of the output shaft 21 and the steering pinion 61. Thus, the rotation direction of the steering wheel 8 and the direction of the steering angle of the steered wheels 7 are matched. As a result, no gear device or the like is needed to reverse the rotation direction of the output shaft 21 again.

As shown in FIG. 1, tie rods 66 and knuckle arms (not shown) are provided at both ends of the steering rack bar 63. The steering rack bar 63 is linked to the left and right steered wheels 7 through the tie rods 66 and the knuckle arms. Thus, the left and right steered wheels 7 are steered in correspondence to the amount of movement of the steering rack bar 63. Tie rod axial force sensors 85 are provided at the tie rods 66, respectively, to detect a rotation force generated between the steered wheels 7 and road surface. Vehicle speed sensors 86 are provided for the steered wheels 7, respectively, to detect rotation speeds of the steered wheels 7.

The control ECU 70 includes a reaction force application motor control circuit 71, a reaction force application inverter 72, a steering direction control motor control circuit 75 and a steering direction control inverter 76. The reaction force control circuit 71 is formed of a computer, which includes a CPU, a ROM, a RAM, an I/O, a bus line and the like. The reaction force control circuit 71, particularly its CPU, is configured by being programmed to control the reaction force control inverter 72, so that electric power supply condition to the reaction force application motor 45 is switched to control drive condition of the reaction force application motor 45. In the reaction force control inverter 72, a plurality of switching elements is connected in a bridge form. By switching over on and off of the switching elements, the power supply condition to the reaction force application motor 45 is switched over.

The direction control circuit 75 is also formed of a computer, which includes a CPU, a ROM, a RAM, an I/O, a bus line and the like in the similar manner as the reaction force control circuit 71. The direction control circuit 75, particularly its CPU, is configured by being programmed to control the inverter 76, so that electric power supply condition to the steering direction control motor 55 is switched to control drive condition of the steering direction control motor 55.

The control ECU 70 is connected to the steering wheel angle sensor 81, the torque sensor 82, the pinion angle sensor 83, the tie rod axial force sensor 85 and the vehicle speed sensors 86 to acquire the steering wheel angle θh, the input shaft torque Tsn, the pinion angle θp, a rotation force generated between the steered wheels 7 and the road surface and the vehicle speed. The control ECU 70 is also connected to a rotation angle sensor 46 and a rotation angle sensor 56. The rotation angle sensor 46 detects a rotation angle of the reactive force application motor 45. The rotation angle sensor 56 detects a rotation angle of the steering direction control motor 55. The control ECU 70 thus acquires the rotation angles of the reaction force application motor 45 and the steering direction control motor 55. The control ECU 70 is further connected to a yaw rate sensor 88, a vehicle longitudinal G sensor 89 and the like. The yaw rate sensor 88 detects a yaw rate of the vehicle. The control ECU 70 thus acquires the yaw rate and the acceleration in the longitudinal direction of the vehicle. The control ECU 70 is connected a vehicle CAN (controller area network) 79 and configured to acquire a variety of information such as a travel speed of the vehicle.

The information acquired by the tie rod axial force sensor 85 corresponds to steered wheel rotation force information related to rotation force generated between the steered wheels and the road surface. The information acquired by the yaw rate sensor 88 or the vehicle longitudinal G sensor 89 corresponds to vehicle moment information related to vehicle moment. The steered wheel rotation force information, the vehicle moment information, the travel speed information acquired from the vehicle CAN 79 and related to the travel speed of the vehicle and the information related to the wheel speeds acquired from the wheel speed sensors 86 form condition information of the vehicle.

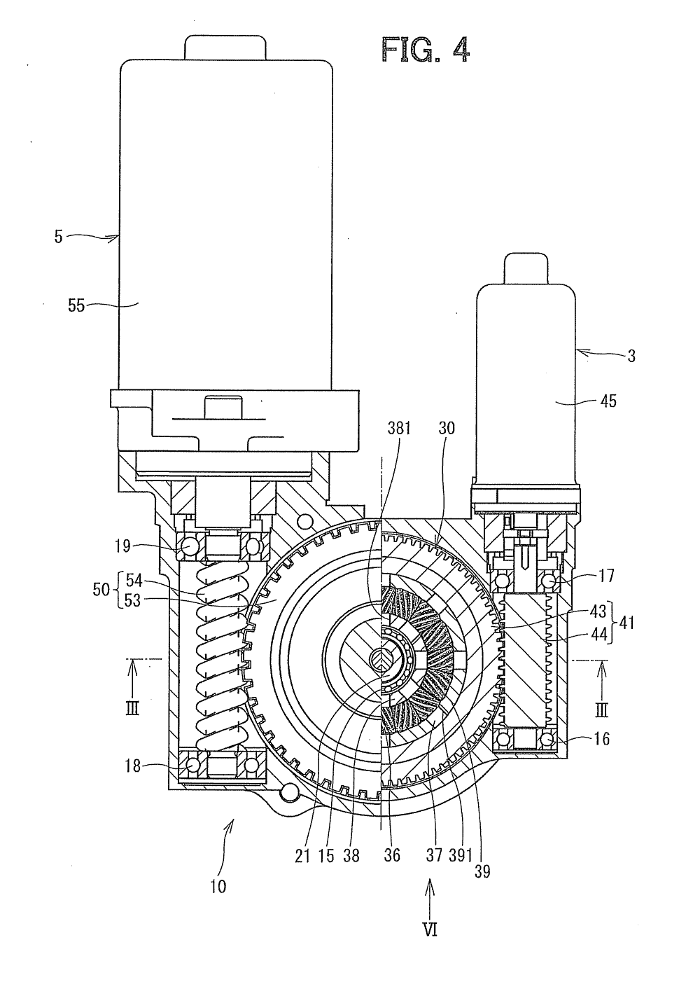

The steering control module 10 will be described below with reference to FIGS. 3 and 4. FIG. 3 shows a section taken along a line in FIG. 4 and FIG. 4 shows a section taken along a line IV-IV in FIG. 3.

The steering control module 10 includes the input shaft 11, the housing 12, the output shaft 21, the reaction force application device 3, the direction control device 5 and the like. The housing 12 is formed of a housing body 121 and an end frame 122. The housing body 121 and the end frame 122 are fixed by screws 123. The reaction force application unit 30 and the like are accommodated in the housing 12, and the input shaft 11 and the output shaft 21 are inserted into the housing 12. A first bearing 13, which rotatably supports an input gear 33, is provided in the housing body 121 at a side opposite to the end frame 122. A second bearing 14 is provided in the end frame 122 to rotatably support the output shaft 21.

The reaction force application device 3 has the differential reduction unit 30 and the reaction force application motor 45 as the second motor, which drives the reaction force application unit 30. The reaction force application unit 30 is formed of a differential gear 31 and a worm gear 41. The differential gear 31 has an input gear 33, an output gear 34 and a pinion gear 36. The worm gear 41 has a differential reduction worm wheel 43 as a second gear and a differential reduction worm 44 as a first gear.

The input gear 33 is provided on the input shaft 11 at a side opposite to the steering wheel 8. The input gear 33 is an umbrella wheel gear, which meshes the pinion gear 36. The input gear 33 has a cylindrical part 331 and au umbrella-shaped gear section 332 provided radially outside the cylindrical part 331. The input shaft 11 is press-fitted into the cylindrical part 331. The cylindrical part 331 is rotatably supported in the housing body 121 by the first bearing 13 provided in the housing body 121. The input shaft 11 and the input gear 33 are thus supported rotatably in the housing 12. The output shaft 21 is inserted into the input gear 33 at a side opposite to the input shaft 11. A needle bearing 333 is provided between the input gear 33 and the output shaft 21. The output shaft 21 is rotatably supported by the input shaft 11. That is, the input shaft 11 and the output shaft 21 are relatively rotatable.

The output gear 34 is provided to face a gear part 332 of the input gear 33 with the pinion gear 36 therebetween. The output gear 34 is an umbrella gear, which meshes the pinion gear, and made of metal or resin. The output shaft 21 is press-inserted into the output gear 34. The output gear 34 is positioned at a side more separated from the input shaft 11 than the needle bearing 333 in the axial direction.

A plurality of pinion gears 36 is provided between the input gear 33 and the output gear 34. The pinion gear 36 is an umbrella wheel gear, which meshes the input gear 33 and the output gear 34. The input gear 33, the output gear 34 and the plurality of pinion gears 36 are set as follows. The number of teeth of the pinion gear 36 is even. The numbers of teeth of the input gear 33 and the output gear 34 are the same and odd. Thus, the teeth contact point between the input gear 33 and the pinion gear 36 changes with rotation. Similarly, the teeth contact point between the output gear 34 and the pinion gear 36 changes with rotation. Therefore, it is less likely that wear of a specified tooth progresses and local wear shortens durability. It is possible to change the number of teeth of the pinion gear 36 to be odd and set the numbers of the teeth of the input gear 33 and the output gear 34 to the same even number.

The input gear 33, the output gear 34 and the pinion gear 36 have spiral teeth so that rate of meshing between the input gear 33 and the pinion gear 36 and the rate of meshing between the output gear 34 and the pinion gear 36 are increased. Thus, operation sound generated by abutting of teeth can be reduced and ripple vibration transferred from the steering wheel 8 to a driver can be reduced. In case that the input gear 33 and the output gear 34 are made of metal, the pinion gear 36 is made of resin. In case that the input gear 33 and the output gear 34 are made of resin, the pinion gear 36 is made of metal. Thus, sound of hitting generated when gears mesh can be reduced.

The pinion gear 36 is positioned radially outside the output shaft 21 so that its rotation axis perpendicularly crosses the rotation axes of the input shaft 11 and the output shaft 21. The pinion gear 36 is formed an axial hole, through which a pinion gear shaft member 37 is passed. The axial hole formed in the pinion gear 36 is formed to have a diameter, which is slightly larger than an outer diameter of the pinion gear shaft member 37.

A third bearing 15 and an inner ring member 38 are provided between the pinion gear 36 and the output shaft 21. The third bearing 15 is positioned between the needle bearing 333 and the output gear 34 in the axial direction and between the output shaft 21 and the inner ring member 38 in the radial direction. The third bearing 15 thus rotatably supports the inner ring member 38 at a position radially outside the output shaft 21.

The inner ring member 38 is formed first holes 381, which pass in a direction perpendicular to the rotation axis of the output shaft 21. The first holes 381 are formed equi-angularly in the circumferential direction of the inner ring member 38. One axial end of the pinion gear shaft member 37, which is passed through the pinion gear 36, is press-fitted in the first hole 381.

An outer ring member 39 is provided radially outside the inner ring member 38 sandwiching the pinion gear 36. The outer ring member 39 is formed second holes 391, which pass in a direction perpendicular to the rotation axis of the output shaft 21. The second holes 391 are formed equi-angularly in the circumferential direction of the outer ring member 39. The second holes 421 are formed at positions, which correspond to the first holes 381 of the inner ring member 38. The other axial end of the pinion gear shaft member 37, which is passed through the pinion gear 36, is press-fitted in the second hole 391. Thus, the pinion gear shaft member 37 is maintained by the inner ring member 38 and the outer ring member 39. Further, the pinion gear 36 is positioned between the inner ring member 38 and the outer ring member 39 to be rotatable about an axis of the pinion gear shaft member 37, which is supported by the inner ring member 38 and the outer ring member 39. According to this configuration, the pinion gear shaft member 37 can be formed and assembled readily.

The differential reduction worm wheel 43 is made of resin or metal and press-fitted on the radially outside part of the outer ring member 39. That is, the output shaft 21, the third bearing 15, the inner ring member 38, the pinion gear 36, the outer ring member 39 and the differential reduction worm wheel 43 are arranged in this order from the radially inside part. The outer ring member 39, the pinion gear shaft member 37 and the differential reduction worm wheel 43 rotate together with the inner ring member 38, which is rotatably supported by the third bearing 15.

As shown in FIG. 4, the differential reduction worm 44 meshes the radially outside part of the differential reduction worm wheel 43. The differential reduction worm 44 is supported rotatably by a fourth bearing 16 and a fifth bearing 17 provided in the housing 12. The lead angles of the differential reduction worm wheel 43 and the differential reduction worm 44 are set to be smaller than a friction angle. As a result, the differential reduction worm wheel 43 is rotated by the rotation of the differential reduction worm 44. However, the differential reduction worm 44 is not rotated by the rotation of the differential reduction worm wheel 43. Thus, the differential reduction worm wheel 43 and the differential reduction worm 44 are capable of self-locking. When the differential reduction worm wheel 43 and the differential reduction worm 44 are self-locked, the ratio of rotations of the input shaft 11 and the output shaft 21 is fixed. The self-locking mechanism provided by the differential reduction worm wheel 43 and the differential reduction worm 44 corresponds to a fixing part. The speed increase ratio Z is 1 when the differential reduction worm wheel 50 and the differential reduction worm 44 are self-locked. The differential reduction worm wheel 43 is formed such that its tooth bottom is distant from the rotation axis by a constant distance. Thus, even if positions of the differential reduction worm wheel 43 and the differential reduction worm 44 deviate in the direction of rotation axis because of manufacturing tolerance, the teeth abutting relation in both rotations in the normal direction and in the reverse direction is maintained.

The reaction force application motor 45 is provided at a side of the fifth bearing 17, which rotatably supports the differential reduction worm 44. The reaction force application motor 45 is a brush-type motor, but may be any other motors such as a brushless motor. The reaction force application motor 45 drives the differential reduction worm 44 in normal and reverse rotation directions when supplied with electric power. When the differential reduction worm 44 is driven to rotate, the differential worm wheel 43, the outer ring member 39, the inner ring member 38 and the pinion gear shaft member 37 are driven to rotate. The reaction force applied to the steering wheel 8 is controlled by controlling the differential reduction worm 44 by the reaction force application motor 45.

The direction control device 5 is provided at a side opposite to the reaction force application device 3 while sandwiching the input shaft 11 and the output shaft 21. The direction control device 5 includes the gear unit 50 and the steering direction control motor 55. The gear unit 50 includes a steering direction control worm wheel 53 and a steering direction control worm 54. The wheel and the steering direction control worm 54 are accommodated in the housing 12. The steering direction control wheel 53 is formed of resin or metal. The steering direction control wheel 53 is press-fitted with the output shaft 21 and rotates together with the output shaft 21.

The steering direction control worm 54 meshes the radially outside of the steering direction control wheel 53. The steering direction control worm 54 is rotatably supported by a sixth bearing 18 and a seventh bearing 19 formed in the housing 12. The tooth lines of the steering direction control wheel 53 are formed in parallel to the rotation axis of the steering direction control wheel 53. The tooth bottom of the wheel is not in an arcuate surface but in a plane surface. Thus, even if the location of mounting the steering direction control wheel 53 deviates in the axial direction of the output shaft 21, the teeth contact condition between the steering direction control wheel 53 and the steering direction control worm 54 can be maintained in a similar condition between the forward rotation time and the reverse rotation time.

The steering direction control motor 55 is provided at a side of a seventh bearing 19, which rotatably supports the steering direction control worm 54. The reaction force application motor 45 is a brushless three-phase motor, but may be any other motors such as a brush-type motor. The steering direction control motor 55 drives the steering direction control worm 54 in normal and reverse rotation directions when supplied with electric power. Thus, the steering direction control wheel 53 meshed with the steering direction control worm 54 is driven to rotate in the normal and reverse directions. By driving the steering direction control wheel 53 fitted with the output shaft 21 to rotate in the normal and reverse directions, the rotation angle of the output shaft 21 is controlled and hence the steering angle θt of the steered wheels 7 is controlled.

The reaction force application device 3 and the direction control device 5 are located at opposite positions in a manner to sandwich the output shaft 21 therebetween. As a result, load generated in the radial direction when the reaction force application motor 45 and the steering direction control motor 55 are driven is cancelled so that the output shaft 21 is suppressed from inclining. Since inclination of the output shaft 21 is suppressed, the position of meshing of the wheel 43 and the differential reduction worm 44 and the position of meshing of the steering direction control wheel 53 and the steering direction control worm 54 are maintained surely.

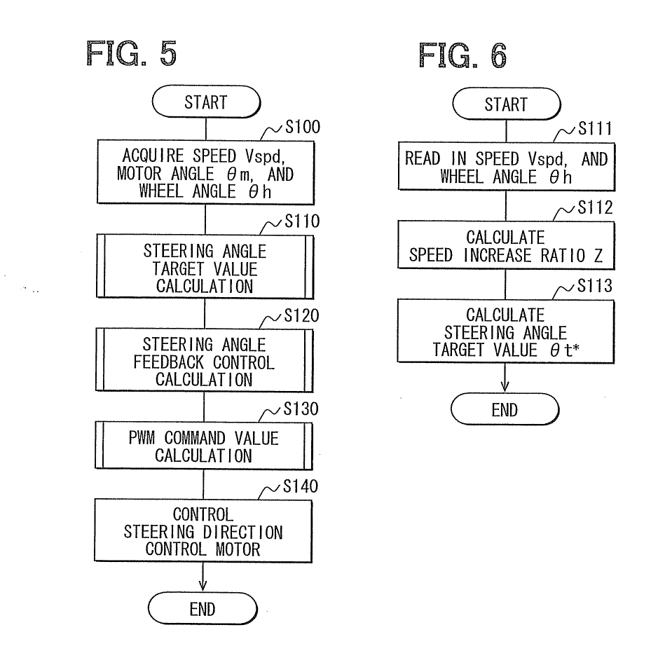

Next, control processing for the steering direction control motor 55, which is programmed to be performed by the direction control circuit 75 of the control ECU 70, will be described with reference to FIGS. 5 to 9. The control calculation processing related to drive control for the steering direction control motor 55 by the control circuit 75 is shown in FIG. 5. In the following description step is abbreviated as “S.”

At step S100, a vehicle speed Vspd, which is a travel speed of the vehicle, is acquired from the vehicle CAN 79. Further, a rotation angle θm of the steering direction control motor 55 is acquired from the rotation angle sensor 56. Further, a steering wheel angle θh is acquired from the steering wheel angle sensor 81. At S110, steering angle target value calculation processing is performed. At S120, steering angle feedback control calculation processing is performed. At S130, PWM command value calculation processing is performed. At S140, driving of the steering direction control motor 55 is controlled by switching over on and off of switching elements forming the inverter 76 is controlled based on a PWM command value calculated at S130.

The steering angle target value calculation processing at S110 is shown as flowchart in FIG. 6.

At S111, the vehicle speed Vspd and the steering wheel angle θh acquired at S100 are read in. At S112, a speed increase ratio Z is acquired based on the vehicle speed Vspd. The relation between the vehicle speed Vspd and the speed increase ratio Z is stored in a data map form as shown in FIG. 9. The speed increase ratio Z is a ratio between the steering wheel angle θh and the pinion angle θp. The pinion angle θp is calculated by multiplying the steering wheel angle θh by the speed increase ratio Z. If the speed increase ratio Z is 1, the steering wheel angle θh and the pinion angle θp coincide. As described above, the rotation direction of the input shaft 11 and the rotation direction of the output shaft 21 are opposite. For this reason, if the speed increase ratio Z is 1, when the input shaft 11 is rotated by an angle θx in the right direction, the output shaft 21 is rotated by the same angle θx in the left direction when viewed from the steering wheel 8 side.

At S113, a steering angle target value θt* is calculated based on the speed increase ratio Z and the steering wheel angle θh. The steering angle target value t* is calculated by the following equation (1).

θt*=Z×n1×θh (1)

Here, n1 is a change amount in the steering angle θt of the steered wheels 7 relative to the steering wheel angle θh.

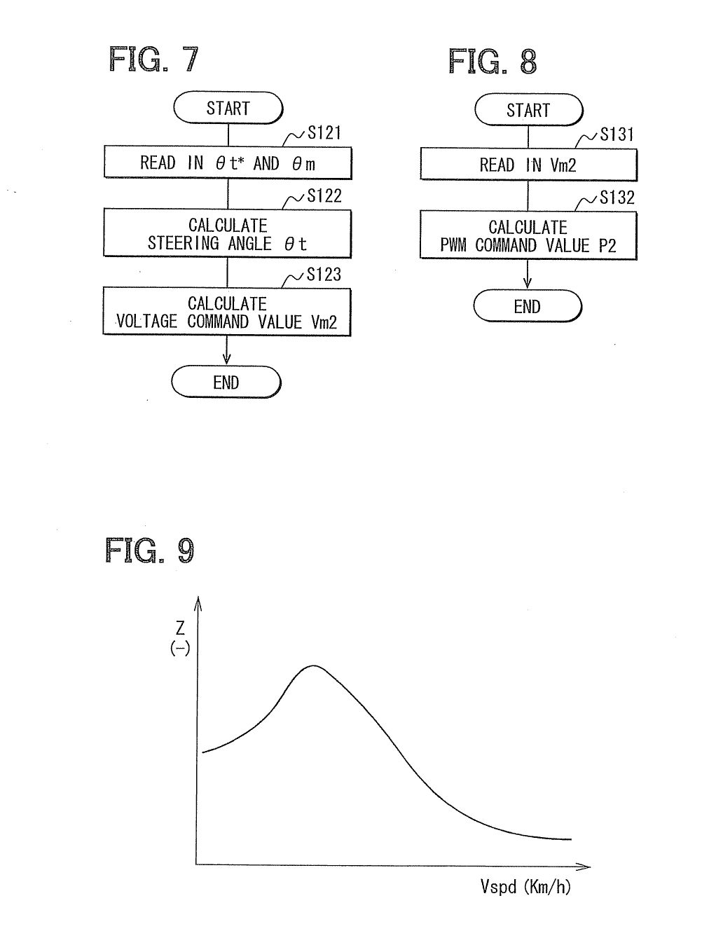

Next, the steering angle feedback control calculation processing at S120 is shown in FIG. 7.

At S121, the rotation angle θm acquired at S100 and the steering angle target value θt* calculated at S113 are read in. At S122, the steering angle θt of the steered wheel 7 is calculated. The steering angle θt is calculated by the following equation (2) as an actual steering angle.

θt=θm×n2 (2)

Here, n2 is a change amount in the steering angle θt of the steered wheels 7 relative to the rotation angle θm of the steering direction control motor 55. At S123, a voltage command value Vm2, which is to be supplied to the steering direction control motor 55 is calculated. The voltage command value Vm2 is feedback-controlled by P-I control based on the steering angle θt of the steered wheel 7 calculated at S122 and the steering angle target value θt* calculated at S113. Assuming that the proportional gain is KP2 and the integral gain is KI2 in the steering direction control motor 55, the voltage command value Vm2 is calculated by the following equation (3).

Vm2=KP2×(θt*−θt)+KI2×∫(θt*−θt)dt (3)

The PWM command value calculation processing at S130 is shown in FIG. 8.

At S131, the voltage command value Vm2 calculated at S123 is read in. At S132, a PWM command value P2 for the steering direction control motor 55 is calculated. The PWM command value P2 is calculated by the following equation (4), assuming that a battery voltage is Vb.

P2=Vm2/Vb×100 (4)

In the direction control circuit 75, driving of the motor 55 is controlled (S140 in FIG. 5) by controlling on/off timing of the switching elements forming the inverter 76 based on the PWM command value P2 calculated at S132.

Next, control processing for the reaction force application motor 45, which is programmed to be performed by the reaction force control circuit 71 of the control ECU 70, will be described with reference to FIGS. 10 to 15. The control calculation processing related to drive control for the reaction force application motor 45 by the reaction force control circuit 71 is shown in FIG. 10.

At S200, the vehicle speed Vspd is acquired from the vehicle CAN 79. Further, the input shaft torque Tsn of the input shaft 11 is acquired from the torque sensor 82. Further, the steering wheel angle θh is acquired from the steering wheel angle sensor 81. At S210, steering angle target value calculation processing is performed. At S220, reaction force feedback control calculation processing is performed. At S230, PWM command value calculation processing is performed. At S240, driving of the reaction force application motor 45 is controlled by switching over on and off of switching elements forming the inverter 75 is controlled based on a PWM command value calculated at S230.

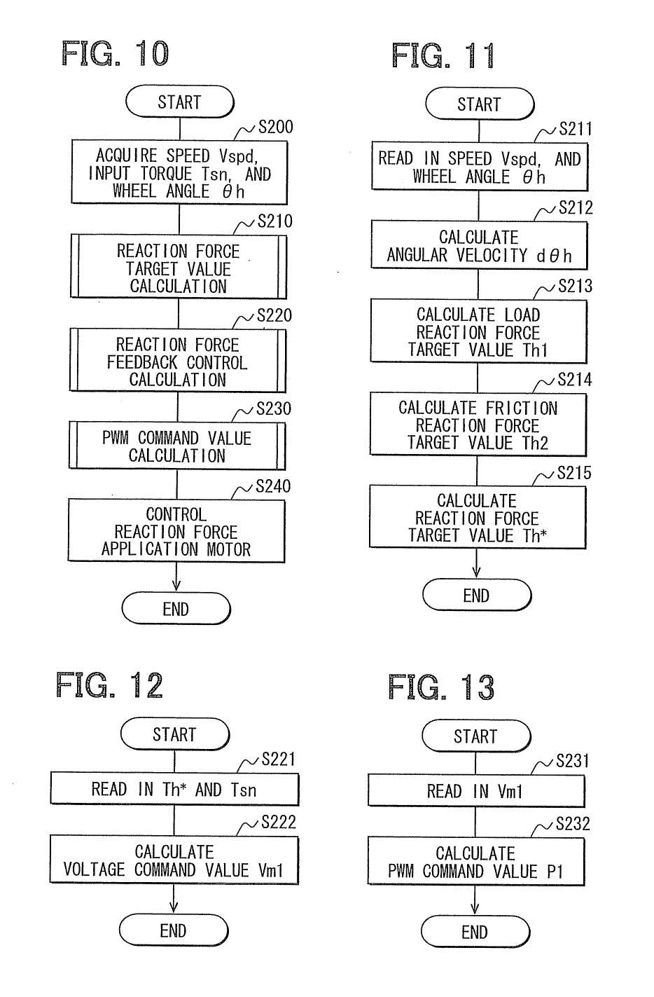

The reaction force target value calculation processing at S210 is shown in FIG. 11.

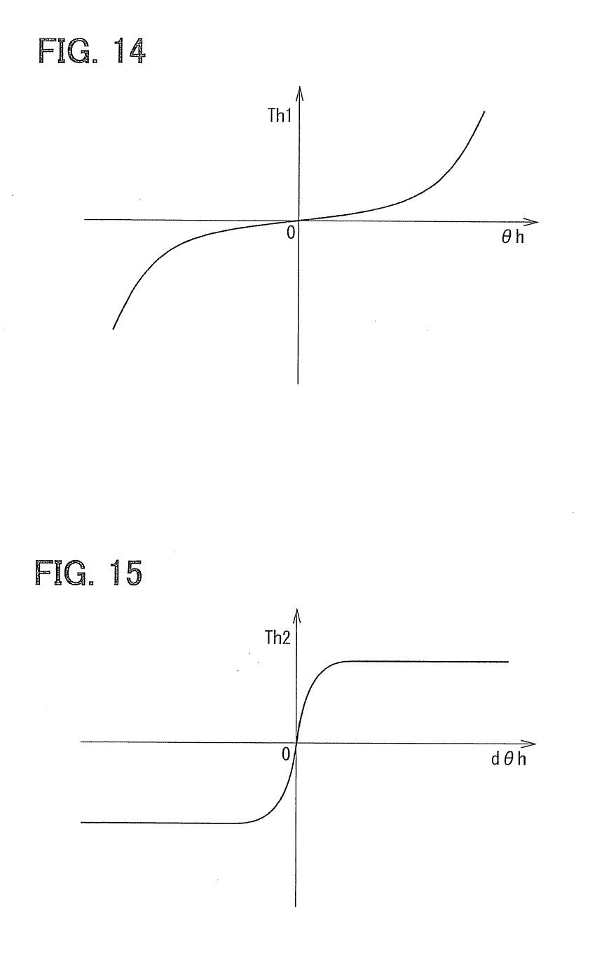

At S211, the vehicle speed Vspd and the steering wheel angle θh acquired at S200 are read in. At S212, a steering wheel angular velocity dθh is calculated based on the steering wheel angle θh read in at S211. At S213, a load reaction force target value Th1 is calculated. The load reaction force target value Th1 is a value related to drive load of the steered wheels 7. The relation between the steering wheel angle θh and the load reaction force target value Th1 is stored in a data map form shown in FIG. 14. The relation between the steering wheel angle θh and the load reaction force target value Th1 in the map form is stored for each of the vehicle speed Vspd. The load reaction force target value Th1 is calculated based on mapped data corresponding to the vehicle speed Vspd. At S214, a friction reaction force target value Th2 is calculated. The friction reaction force target value Th2 is a value related to static friction force of a mechanical mechanism such as the differential reduction unit 30. The steering wheel angular velocity dθh and the friction reaction force target value Th2 are stored in a data map form shown in FIG. 15. The relation between the steering wheel angle θh and the friction reaction force target value Th2 in the map form is stored for each vehicle speed Vspd. The friction reaction force target value Th2 is calculated based on the map data corresponding to the vehicle speed Vspd. At S215, the reaction force target value Th* is calculated based on the load reaction force target value Th1 calculated at S213 and the friction force target value Th2 calculated at S214. The reaction force target value Th* is calculated by the following equation (5).

Th*=Th1+Th2 (5)

The reaction force target value is determined based on the drive load of the steered wheels and the static friction force of the mechanical device. However, it may be determined by further adding dynamic friction force of the mechanical device (force proportional to the steering wheel angular velocity dθh) and/or inertia moment force (force proportional to a differentiation value of the steering wheel angular velocity dθh).

The reaction force feedback control calculation processing at S220 is shown in FIG. 12.

At S221, the input shaft torque Tsn acquired at S200 and the reaction force target value Th* calculated at S215 are read in. At S222, a voltage command value Vm1, which is to be supplied to the reaction force application motor 45 is calculated. The command value Vm1 is feedback-controlled by P-I control based on the input shaft torque Tsn acquired by the torque sensor 82 and read in at S221 and the reaction force target value Th* calculated at S215. Assuming that the proportional gain is KP1 and the integral gain is KI1 in the reaction force application motor 45, the voltage command value Vm1 is calculated by the following equation (6).

Vm1=KP1×(Th*−Tsn)+KI1×∫(Th*−Tsn)dt (6)

The PWM command value calculation processing at S230 is shown in FIG. 13.

At S231, the voltage command value Vm1 calculated at S222 is read in. At S232, a PWM command value P1 for the reaction force application motor 45 is calculated. The PWM command value P1 is calculated by the following equation (7), assuming that the battery voltage is Vb.

P1=Vm1/Vb×100 (7)

In the reaction force control circuit 71, driving of the reaction force application motor 45 is controlled (S240 in FIG. 10) by controlling on/off timing of the switching elements forming the steering direction control inverter 76 based on the PWM command value P1 calculated at S232.

According to the first embodiment described above, the steering control apparatus 1 is formed of the input shaft 11, the output shaft 21, the steering gear box device 6, the steering wheel angle sensor 81, the steering direction control device 5 and the reaction force application device 3. The input shaft 11 is coupled to the steering wheel 8, which is operable by a driver. The output shaft 21 is provided rotatably relative to the input shaft 11. The steering gear box device 6 converts the rotary motion of the output shaft 21 to the linear motion and varies the steering angle θt by swinging the steered wheels 7. The steering wheel angle sensor 81 detects the steering wheel angle θh as the operation amount of the input shaft, which varies with steering operation of the steering wheel 8. The direction control device 5 includes the steering direction control motor 55 and controls the steering angle θt of the steered wheels 7 by driving the steering direction control motor 55 based on the steering wheel angle θh. The reaction force application device 3 is provided closer to the steering wheel 8 than the direction control device 5. The reaction force application device 3 includes a differential reduction unit 30 and a reaction force application motor 45. The differential reduction unit 30 transfers rotation of the input shaft 11 to the output shaft 21. The reaction force application motor 45 drives the differential reduction worm 44 forming the differential reduction unit 30. The reaction force application device 3 applies steering reaction force to the steering wheel 8 by driving the reaction force application motor 45.

The steering wheel 8 and the steered wheels 7 are mechanically coupled normally through the differential reduction unit 30, the output shaft 21, the steering gear box device 6 and the like. The steering angle θt of the steered wheels 7 is controlled electrically by controlling driving of the steering direction control motor 55 of the direction control device 5. Thus, steer-by-wire function is provided. That is, the steering control apparatus 1 is a half by-wire type steering system, which has the steer-by-wire function and mechanically links the steering wheel 8 and the steered wheels 7.

Since the steering wheel 8 is mechanically linked to the steered wheels 7, a fail-safe device need not be provided separately. The system is more simplified than the full by-wire system. Since the reaction force application device 3 having the differential reduction unit 30 is provided closer to the steering wheel 8 side than the direction control device 5 is and the reaction force applied to the steering wheel 8 side is controlled by the reaction force application motor 45, the reaction force applied to the steering wheel 8 can be controlled more appropriately in comparison to the conventional EPS apparatus. If a vehicle is assumed to travel automatically, for example, intervention of a driver will occur in the conventional EPS apparatus because of the mechanical linkage between the steering wheel 8 and the steered wheels 7. However, since the steering control apparatus 1 has the differential reduction unit 30, which is driven by the reaction force application motor 45, between the input shaft 11 and the output shaft 21, linked operation between the input shaft 11 and the output shaft 21 is eliminated and intervention of the driver can be reduced.

The differential reduction unit 30 includes the differential reduction worm 44, which is driven to rotate by the reaction force application motor 45, and the differential reduction worm wheel 43 meshing the differential reduction worm 44. The lead angle is set to provide the self-locking function, by which the differential reduction worm wheel 43 rotates by rotation of the differential reduction worm 44 but the differential reduction worm 44 does not rotate by rotation of the differential worm wheel 43. Thus, the differential reduction worm wheel 43 and the differential reduction worm 44 form the self-locking mechanism. When the differential reduction worm wheel 43 and the differential reduction worm 44 are self-locked, the ratio between the rotation speeds of the input shaft 11 and the output shaft 21 is fixed. The steering wheel 8 and the steered wheels 7 are mechanically coupled at normal time. Therefore, by fixing the ratio of rotations between the input shaft 11 and the output shaft 21, the fail-safe operation can be realized readily without separately adding a mechanical linkage device. The self-locking mechanism is provided by appropriately setting the lead angle in the differential reduction worm wheel 43 and the differential reduction worm 44. As a result, no member for fixing the ratio of rotation speeds of the input shaft 11 and the output shaft 21 need be provided separately, and hence the number of parts can be reduced.

The reaction force application motor 45 is controlled based on the input shaft torque Tsn generated in the input shaft 11. Thus, the reaction force can be appropriately controlled based on the input shaft torque Tsn. The torque sensor 82 is provided for detecting the input shaft torque Tsn. Since the input shaft torque Tsn is detected directly, the reaction force can be controlled with high accuracy.

Further, the reaction force application motor 45 is controlled based on the steering wheel angle θh acquired by the steering wheel angle sensor 81. Since the steering wheel angle θh and the turning force of the steered wheels 7 are correlated, the controllability of the vehicle can be improved by controlling the reaction force by the reaction force application motor 45 based on the steering wheel angle θh.

The control ECU 70 acquires vehicle condition information related to the vehicle condition. Such information include the vehicle speed information related to the vehicle travel speed, the steered wheel rotation force information related to rotation force generated between the steered wheels 7 and the road surface, and the vehicle moment information related to the moment of the vehicle. The reaction force application motor 45 is controlled based on the vehicle speed Vspd. Thus, the reaction force applied to the steering wheel 8 side can be appropriately controlled based on the vehicle condition. The steering direction control motor 55 is controlled based on the vehicle speed Vspd. Thus, the steering angle θt of the steered wheels 7 can be appropriately controlled based on the vehicle condition. In controlling the steering direction control motor 55, the speed increase ratio Z is set large when the vehicle speed Vspd is low and the speed increase ratio Z is set small when the vehicle speed Vspd is high. Thus, operability of the steering wheel 8 at low speed travel time and the travel stability of the vehicle at high speed travel time can both be improved. The control ECU 70 corresponds to condition information acquisition means.

### Second Embodiment

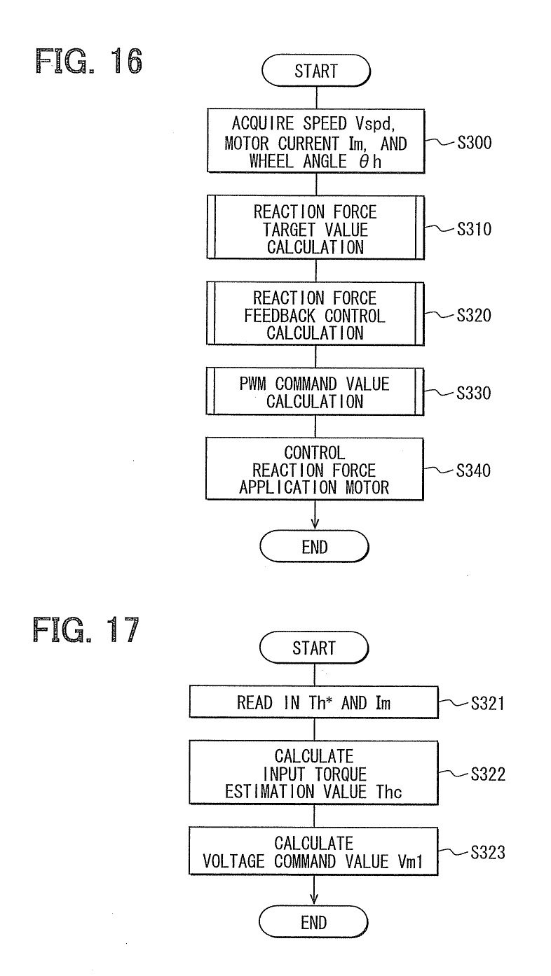

A vehicular control apparatus according to a second embodiment of the present invention is different in control processing for the reaction force application motor 45 and hence only control processing therefor will be described below while omitting other description. The control processing for the reaction force application motor 45 by the reaction force control circuit 71 will be described with reference to FIGS. 16, 17 and the like.

At S300, the vehicle speed Vspd is acquired from the vehicle CAN 79. Further, a motor current Im supplied to the reaction force application motor 45 is acquired. This motor current Im corresponds to the amount of current supplied to the reaction force application motor 45. Further, the steering wheel angle θh is acquired from the steering wheel angle sensor 81. At S310, steering angle target value calculation processing is performed. This steering angle target value calculation processing is the same as that of the first embodiment and performs the same steps shown in FIG. 11. At S320, reaction force feedback control calculation processing is performed. At S330, PWM command value calculation processing is performed. This PWM command value calculation processing is the same as that of the first embodiment and performs the same steps shown in FIG. 13. At S340, driving of the reaction force application motor 45 is controlled by switching over on and off of the switching elements forming the reaction force application inverter 72 based on the PWM command value calculated at S330.

Here, the reaction force feedback control processing at S320 is shown in FIG. 17.

At S321, the reaction force target value Th* calculated at S215 and the motor current Im acquired at S300 are read in. At S322, a torque estimation value Thc of the input shaft torque of the input shaft 11 is calculated. The input shaft torque estimation value Thc is calculated by the following equation (8).

Thc=Im×Km×n3 (8)

Here, Km is a motor torque constant, and n3 is a rotation speed of the reaction force application motor 45 corresponding to the rotation speed of the input shaft 11. Km and n3 are both predetermined constants. At S323, the voltage command value Vm1 applied to the reaction force application motor 45 is calculated. The voltage command value Vm1 is feedback-controlled by P-I control based on the input shaft torque estimation value Thc calculated at S322 and the reaction force target value Th* calculated at S215. Assuming that the proportional gain is KP1 and the integral gain is KI1 in the reaction force application motor 45, the voltage command value Vm1 is calculated by the following equation (9).

Vm1=KP1×(Th*−Thc)+KI1×∫(Th*−Thc)dt (6)

The second embodiment provides the same advantage as the first embodiment. In addition, the input shaft torque is estimated based on the motor current Im supplied to the reaction force application motor 45, the input shaft torque estimation value Thc is calculated and the reaction force is controlled based on the input shaft torque estimation value Thc. Thus, the torque sensor 82 provided in the first embodiment need not be provided and the number of parts can be reduced.

### Other Embodiments

As other embodiments, the first and the second embodiments may be modified as follows.

The reaction force application motor 45 may be controlled based on steered wheel rotation force information, for example, based on data stored in a data map form, which defines a relation between the steered wheel rotation force information and the reaction force for the steering wheel 8. The reaction force application motor 45 may be controlled based on vehicle moment information, for example, based on data stored in a data map form, which defines a relation between the vehicle moment information and the reaction force for the steering wheel 8. Thus, by controlling the reaction force by controlling the reaction force application motor 45, load information such as wheel ruts, lateral wind and the like can be fed back to a driver.

The steering direction control motor 55 may be controlled based on the steered wheel rotation force information. The steering direction control motor 55 may be controlled based on the vehicle moment information.

The vehicle speed Vspd, which is acquired from the vehicle CAN 79, may be calculated from a wheel speed detected by a wheel speed sensor.

According to the first and the second embodiments, the lead angle is set to provide the self-locking function, by which the differential reduction worm wheel 43 rotates by rotation of the differential reduction worm 44 but the differential reduction worm 44 does not rotate by rotation of the differential worm wheel 43. Thus, the differential reduction worm wheel 43 and the differential reduction worm 44 form the self-locking mechanism. However, it is only necessary that the differential reduction unit 30 is a differential unit, which is capable of changing the ratio of rotations between the input shaft 11 and the output shaft 21 by driving a worm gear and self-locking the worm gear. For example, any other units such as a planetary gear-type unit may be used.

The fixing part for fixing the ratio of rotations between the input shaft 11 and the output shaft 21 is not limited to the self-locking mechanism. It is possible to use a separate member such as a lock pin, which fixes the ratio of rotations between the input shaft and the output shaft 21.

According to the first and the second embodiments, the reaction force application device 3 and the steering direction control device 5 are integrated in a single module unit. However, the reaction force application device 3 and the steering direction control device 5 need not be integrated into a module but may be provided separately as long as the reaction force application device 3 is closer to the steering wheel side 8 than the steering direction control device 5. For example, the steering direction control device 5 may be provided on the steering rack bar 63.

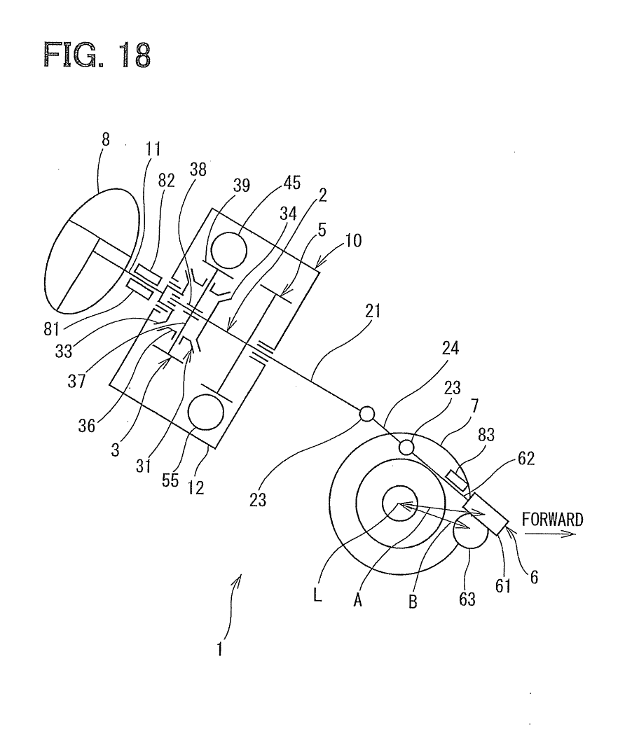

In the first and the second embodiment, the steering gear box device 6 is provided at a more rear side of the vehicle than the line L connecting the rotation centers of the steered wheels 7 as shown in FIG. 2. The steering control apparatus 1 may be configured as shown in FIG. 18. The same or similar parts as the first and the second embodiments are designated by the same reference numerals. As shown in FIG. 18, in the steering control apparatus 1, the steering gear box device 6 may be provided at more forward side of the vehicle than the line L connecting the rotation centers of the steered wheels 7 is. That is, the distance A between the steering pinion 61 and the line L is set longer than the distance B between the steering rack bar 63 and the line L.

In the configuration shown in FIG. 18, the output shaft 21 and the input shaft 11 rotate in opposite directions due to operation of the differential gear 31 provided between the input shaft 11 and the output shaft 21. When the steering wheel 8 is steered in the left direction, the steering pinion 61 rotates in the clockwise direction when viewed from the pinion shaft 62 side. The steering rack bar 63 moves in the left direction and the steering angle of the steered wheels 7 is changed so that the vehicle travels in the left direction. When the steering wheel 8 is steered in the right direction, the steering pinion 61 rotates in the counter-clockwise direction when viewed from the pinion shaft 62 side. The steering rack bar 63 moves in the right direction and the steering angle of the steered wheels 7 is changed so that the vehicle travels in the right direction.

Since the distance A between the line L and the steering pinion 61 is set longer than the distance B between the line L and the steering rack bar 63, that is, A>B, the steered wheels 7 are turned in the direction opposite from the rotation direction of the output shaft 21, the shaft 24 and the steering pinion 61. Thus, the rotation direction of the steering wheel 8 and the direction of steering angle of the steered wheels 7 are matched.

The present invention described above is not limited to the disclosed embodiments but may be implemented as further different embodiments.

What is claimed is:

1. A vehicular steering control apparatus comprising:
an input shaft coupled to a steering member to be operable by a driver;
an output shaft provided rotatably relative to the input shaft;
a steering gear box device for converting rotary motion of the output shaft to linear motion and varying a steering angle of steered wheels;
an operation amount detection part for detecting an operation amount of the input shaft, which varies with steering operation of the steering member;
a steering direction control device including a first motor and configured to control the steering angle of the steered wheels by driving the first motor based on the operation amount of the input shaft detected by the operation amount detection part; and
a steering reaction force application device provided closer to the steering member than the steering direction control device and including a differential reduction unit and a second motor, the differential reduction unit coupling the input shaft and the output shaft to transfer rotation of the input shaft to the output shaft, and the second motor driving the differential reduction unit,
wherein the reaction force application device is configured to apply steering reaction force to the steering member by operation of the second motor.

2. The vehicular steering control apparatus according to claim 1, wherein:
the reaction force application device includes a fixing part, which fixes a ratio of rotations between the input shaft and the output shaft.

3. The vehicular steering control apparatus according to claim 2, wherein:
the differential reduction unit includes a first gear driven to rotate by the second motor and a second gear meshing the first gear; and
the fixing part is a self-locking mechanism having a lead angle for fixing the ratio of rotations between the input shaft and the output shaft, thereby allowing rotation of the second gear by rotation of the first gear and disabling rotation of the first gear by rotation of the second gear.

4. The vehicular steering control apparatus according to claim 1, wherein:
the second motor is controlled based on an input shaft torque of the input shaft.

5. The vehicular steering control apparatus according to claim 4, further comprising:
a torque sensor for detecting the input shaft torque.

6. The vehicular steering control apparatus according to claim 4, wherein:
the input shaft torque is estimated based on an amount of current supplied to the second motor.

7. The vehicular steering control apparatus according to claim 1, wherein:
the second motor is controlled based on an operation amount of the input shaft.

8. The vehicular steering control apparatus according to claim 1, further comprising:
a condition information acquisition part for acquiring condition information about vehicle condition.

9. The vehicular steering control apparatus according to claim 8, wherein:
the second motor is controlled based on the condition information acquired by the condition information acquisition part.

10. The vehicular steering control apparatus according to claim 8, wherein:
the first motor is controlled based on the condition information acquired by the condition information acquisition part.

11. The vehicular steering control apparatus according to claim 8, wherein:
the condition information includes travel speed information relating to a travel speed of a vehicle.

12. The vehicular steering control apparatus according to claim 8, wherein:
the condition information includes steered wheel rotation force information relating to rotation force generated between the steered wheels and a road surface.

13. The vehicular steering control apparatus according to claim 8, wherein:
the condition information includes vehicle moment information relating to moment of a vehicle.
